(19) United States
(12) Patent Application Publication
(10) Pub. No.: US 2019/0155889 A1
(43) Pub. Date: May 23, 2019

(54) DOCUMENT PROCESSING APPARATUS AND NON-TRANSITORY COMPUTER READABLE MEDIUM

(71) Applicant: FUJI XEROX CO., LTD., Tokyo (JP)

(72) Inventors: Yoshie OHIRA, Kanagawa (JP); Masayuki IWASAWA, Kanagawa (JP); Shingo KATO, Kanagawa (JP)

(73) Assignee: FUJI XEROX CO., LTD., Tokyo (JP)

(21) Appl. No.: 16/179,283

(22) Filed: Nov. 2, 2018

(30) Foreign Application Priority Data
Nov. 17, 2017 (JP) 2017-222147

(51) Int. Cl. G06F 17/24; G06K 9/00

(52) U.S. Cl. CPC G06F 17/243; G06K 9/00449; G06K 2209/01; G06K 9/00469; G06K 9/00456

(57) ABSTRACT

A document processing apparatus includes a reception unit and a display control unit. The reception unit receives specification of a region in an electronic document by a user. The display control unit performs control such that a candidate for attribute information is displayed from a string in the region received by the reception unit, based on determination information as information for determining a type of attribute information.

### CROSS-REFERENCE TO RELATED APPLICATIONS

This application is based on and claims priority under 35 USC 119 from Japanese Patent Application No. 2017-222147 filed Nov. 17, 2017.

### BACKGROUND

### Technical Field

The present invention relates to a document processing apparatus and a non-transitory computer readable medium.

### SUMMARY

According to an aspect of the invention, there is provided a document processing apparatus including a reception unit and a display control unit. The reception unit receives specification of a region in an electronic document by a user. The display control unit performs control such that a candidate for attribute information is displayed from a string in the region received by the reception unit, based on determination information as information for determining a type of attribute information.

### BRIEF DESCRIPTION OF THE DRAWINGS

Exemplary embodiments of the present invention will be described in detail based on the following figures, wherein:

FIG. 1 is a diagram illustrating a configuration of a document management system according to an exemplary embodiment of the present invention;

FIG. 2 is a block diagram illustrating a hardware configuration of a document processing apparatus according to an exemplary embodiment of the present invention;

FIG. 3 is a block diagram illustrating a functional configuration of a document processing apparatus according to an exemplary embodiment of the present invention;

FIG. 4 is a diagram illustrating an example of a display screen of a document processing apparatus;

FIG. 5 is a diagram illustrating an example of a display screen for setting and registering attribute information of the document processing apparatus;

FIG. 6 is a diagram illustrating an example of a display screen for setting and registering attribute information of the document processing apparatus;

FIG. 7 is a diagram illustrating an example of a display screen for setting and registering attribute information of the document processing apparatus;

FIG. 8 is a diagram illustrating an example of a display screen for setting and registering attribute information of the document processing apparatus;

FIG. 9 is a flowchart diagram for explaining a setting operation for adding attribute information to document data of the document processing apparatus;

FIG. 10 is a flowchart diagram for explaining an operation for adding attribute information to document data of the document processing apparatus;

FIG. 11 is a diagram illustrating an example of a display screen for adding attribute information to document data of the document processing apparatus;

FIG. 12 is a diagram illustrating an example of a display screen for adding attribute information to document data of the document processing apparatus;

FIG. 13 is a diagram illustrating an example of a display screen for adding attribute information to document data of the document processing apparatus; and

FIG. 14 is a diagram illustrating an example of a display screen for adding attribute information to document data of the document processing apparatus.

### DETAILED DESCRIPTION

Hereinafter, exemplary embodiments of the present invention will be described in detail with reference to drawings.

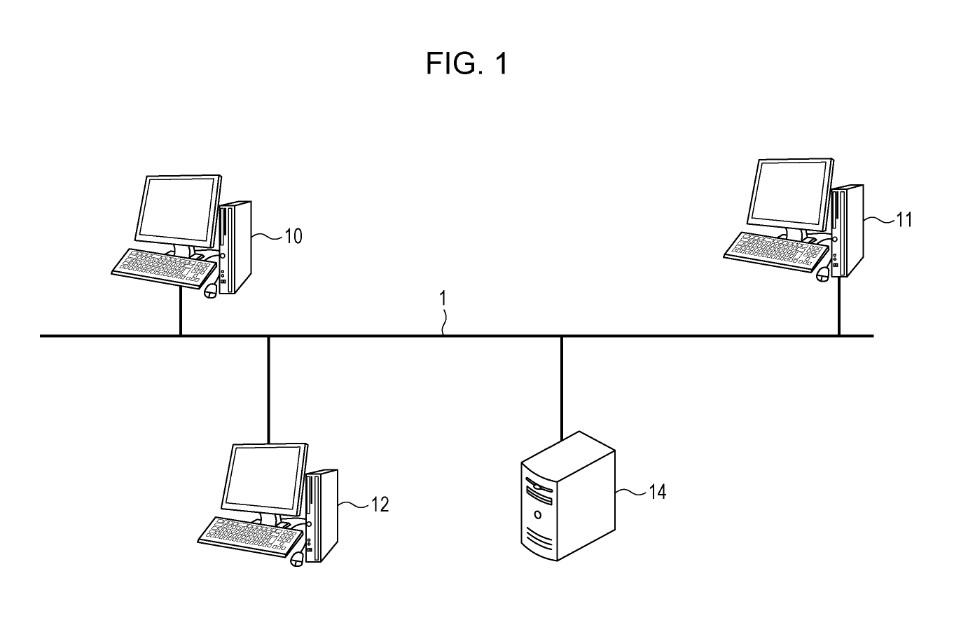

FIG. 1 is a diagram illustrating a system configuration of a document management system according to an exemplary embodiment of the present invention.

A document management system according to an exemplary embodiment of the present invention includes, as illustrated in FIG. 1, document processing apparatuses 10 to 12 such as personal computers that are connected to one another via a network 1 and a server apparatus 14.

Attribute information adding software is installed into the document processing apparatuses 10 to 12. An attribute information adding program is executed by the attribute information adding software, so that attribute information is added to document data as an electronic document. Accordingly, classification of plural pieces of document data may be achieved.

Furthermore, the document processing apparatuses 10 to 12 may transmit, receive, browse, and correct document data generated by adding attribute information thereto and files in which such document data are stored.

Furthermore, the server apparatus 14 is connected to the document processing apparatuses 10 to 12 via the network 1. Document data generated by adding attribute information thereto by the document processing apparatuses 10 to 12 and files in which such document data are stored may be stored in the server apparatus 14. The document processing apparatuses 10 to 12 are able to read document data generated by adding attribute information thereto and files in which such document data are stored, the document data and files being stored in the server apparatus 14. Therefore, the document processing apparatuses 10 to 12 are able to transfer the document data and files via the server apparatus 14.

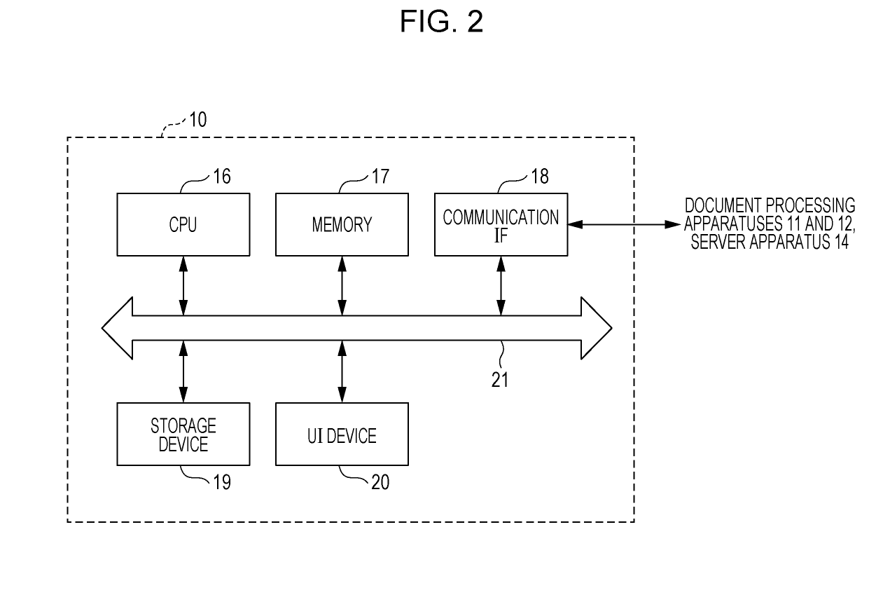

FIG. 2 illustrates a hardware configuration of the document processing apparatus 10 in the document management system according to an exemplary embodiment. Configurations of the document processing apparatuses 11 and 12 are the same as the configuration of the document processing apparatus 10, and therefore, explanation for the configurations of the document processing apparatuses 11 and 12 will be omitted.

As illustrated in FIG. 2, the document processing apparatus 10 includes a central processing unit (CPU) 16, a memory 17, a communication interface (IF) 18 that performs transmission and reception of data to and from an external apparatus or the like via the network 1, a storage device 19 such as a hard disk drive (HDD), and a user interface (UI) device 20 that includes a touch panel or a liquid crystal display and a keyboard. These components are connected to one another via a control bus 21.

The CPU 16 controls an operation of the document processing apparatus 10 by executing a predetermined process based on an attribute information adding program stored in the memory 17 or the storage device 19. In this exemplary embodiment, the CPU 16 is explained as a unit that reads and executes the attribute information adding program stored in the memory 17 or the storage device 19. However, the program may be stored in a storing medium such as a compact disc-read only memory (CD-ROM) or the like and provided to the CPU 16.

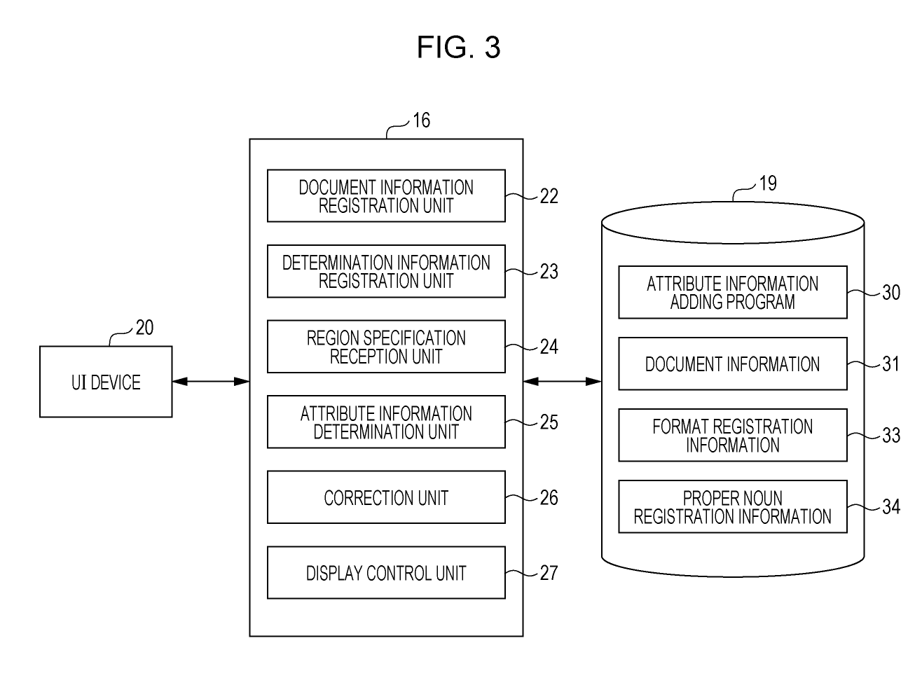

FIG. 3 is a block diagram illustrating a functional configuration of the document processing apparatus 10 that is implemented by execution of the attribute information adding program.

The document processing apparatus 10 functions as a document information registration unit 22, a determination information registration unit 23, a region specification reception unit 24, an attribute information determination unit 25, a correction unit 26, a display control unit 27, and the like when the CPU 16 as a controller executes an attribute information adding program 30 stored in the storage device 19.

The storage device 19 stores the attribute information adding program 30, document information 31, format registration information 33, proper noun registration information 34, and the like.

The attribute information adding program 30 is a program that causes the CPU 16 to operate as the document information registration unit 22, the determination information registration unit 23, the region specification reception unit 24, the attribute information determination unit 25, the correction unit 26, the display control unit 27, and the like.

The document information 31 is, for example, information such as text information, image information, and moving image information, and includes document information generated by adding attribute information thereto.

The format registration information 33 and the proper noun registration information 34 are used as determination information, which is information for determining the type of attribute information. The format registration information 33 and the proper noun registration information 34 are registered in advance in the storage device 19.

The format registration information 33 is format information corresponding to the type of attribute (attribute name). A format for determining the type of attribute information is registered in the format registration information 33. For example, format information such as “Month Day, Year” or “MM/DD/YY” is registered for an attribute name of “date”. Furthermore, format information such as “AA Corporation”, “AA Co., Ltd.”, “AA Company Limited”, or “AA Limited” is registered for an attribute name of “name of business partner”. Furthermore, format information such as “xx Yen”, “Yxx”, or “$xx” is registered for an attribute name of “amount”.

A proper noun such as a string that may be registered as an attribute or a string that is frequently used as attribute information, for example, “ABC Corporation”, “DEF Co., Ltd.”, or the like is registered as the proper noun registration information 34.

The document information registration unit 22 registers new document information in the document information 31 in the storage device 19 in response to a registration request.

The determination information registration unit 23 registers new determination information in the storage device 19 in response to a registration request. Specifically, the determination information registration unit 23 registers new format information in association with the type of attribute and stores the registered format information in the format registration information 33. Furthermore, the determination information registration unit 23 registers a new type of attribute and stores the registered type in the format registration information 33. Furthermore, the determination information registration unit 23 registers new strings such as a string that may be registered as an attribute and a string that is frequently used as attribute information and stores the registered strings in the proper noun registration information 34.

The region specification reception unit 24 receives specification of a region by a user on a view screen for document data.

The attribute information determination unit 25 extracts a string in a region specified by the region specification reception unit 24, based on determination information such as the format registration information 33, the proper noun registration information 34, or the like stored in the storage device 19.

The correction unit 26 corrects a string in a region specified by the region specification reception unit 24, based on determination information such as the format registration information 33, the proper noun registration information 34, or the like stored in the storage device 19. That is, in a case where a region specified by the region specification reception unit 24 is not an appropriate region or there is an error, the correction unit 26 performs correction based on determination information such as the format registration information 33, the proper noun registration information 34, or the like. For example, the correction unit 26 performs correction so that a string in a specified region becomes the same as a string registered as the proper noun registration information 34. Furthermore, in a case where an unwanted string is included in a region specified by the region specification reception unit 24, based on a comparison with the proper noun registration information 34, the correction unit 26 deletes the unwanted string.

The display control unit 27 performs control such that a string extracted from among strings in a region specified by the region specification reception unit 24 is displayed as a candidate for attribute information, based on determination information such as the format registration information 33, the proper noun registration information 34, or the like stored in the storage device 19. That is, the display control unit 27 performs control such that a string extracted from among strings in a region is automatically input to an input field on a setting screen for an attribute name as the type of attribute corresponding to the string and the input string is displayed as a candidate for attribute information, based on determination information such as the format registration information 33, the proper noun registration information 34, or the like.

Furthermore, in the case where plural pieces of determination information such as the format registration information 33, the proper noun registration information 34, and the like stored in the storage device 19 are included in a region specified by the region specification reception unit 24, the display control unit 27 performs control such that strings corresponding to the plural pieces of determination information are extracted and the extracted strings are displayed as candidates for attribute information. That is, the display control unit 27 performs control such that strings extracted from among strings in a region are automatically input to input fields on a setting screen for attribute names as the types of attribute corresponding to the strings and the input strings are displayed as candidates for attribute information, based on determination information such as the format registration information 33, the proper noun registration information 34, and the like.

Furthermore, the display control unit 27 performs control such that a string corrected by the correction unit 26 is displayed as a candidate for attribute information.

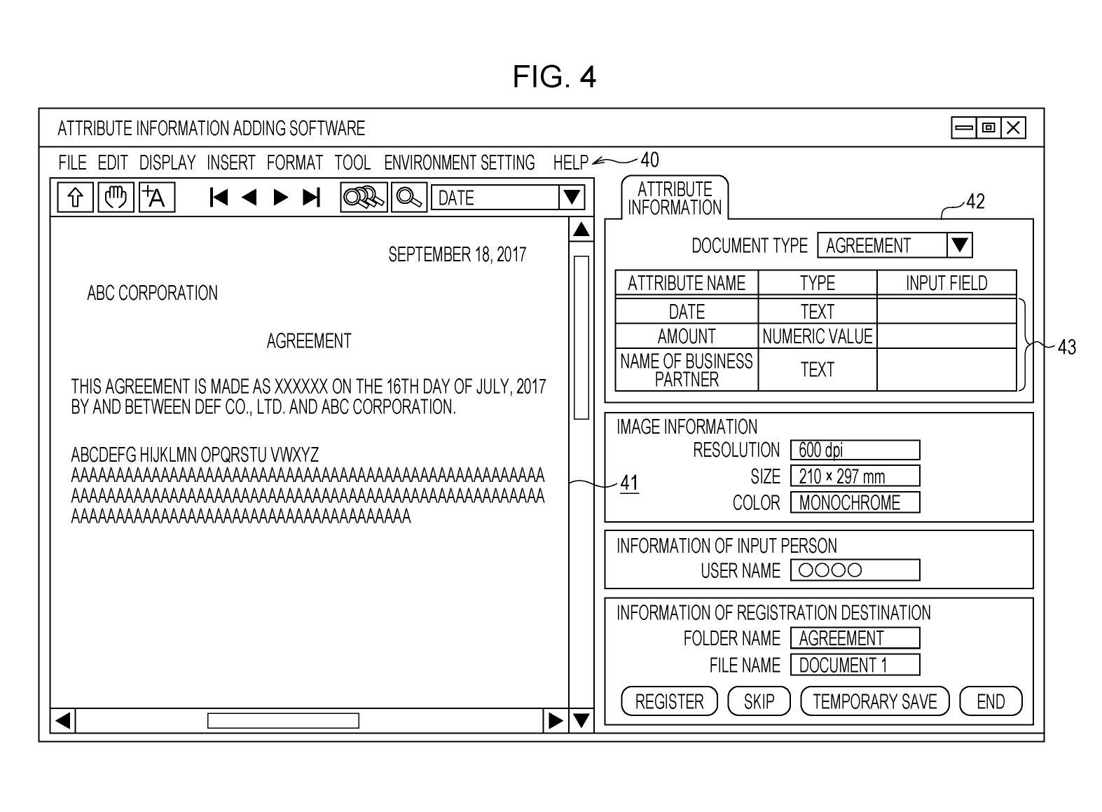

Next, an example of a display screen for a case where attribute information adding software is activated and a file is expanded will be described in detail with reference to FIG. 4.

When the attribute information adding software is activated, a screen for adding attribute information to document data is displayed on the display screen. Specifically, when the attribute information adding program is executed, various functions to be executed on document data are displayed as tools in a tool bar 40 on the display screen. Furthermore, a view screen 41 for document data, a setting screen 42 for adding attribute information, and the like are displayed.

In the document processing apparatus 10, determination information such as the format registration information 33, the proper noun registration information 34, and the like that are registered in advance is used. Therefore, only by specifying a region in the document data displayed on the view screen 41 using a text selection mode in accordance with an operation by a user, a string that is desired to be added as attribute information may be automatically input to an input field 43 on the setting screen 42 and displayed as a candidate for attribute information.

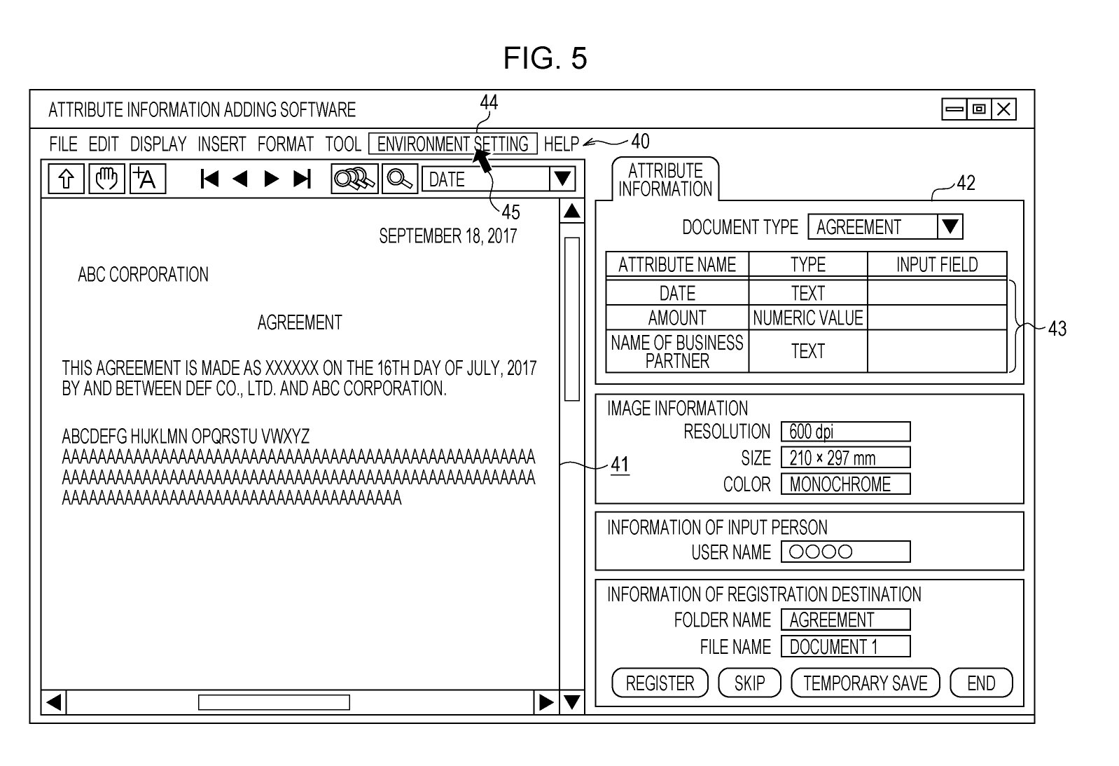

Next, an operation of the determination information registration unit 23 for setting and registering new determination information in the format registration information 33, the proper noun registration information 34, and the like in the storage device 19 will be explained with reference to FIGS. 5 to 8.

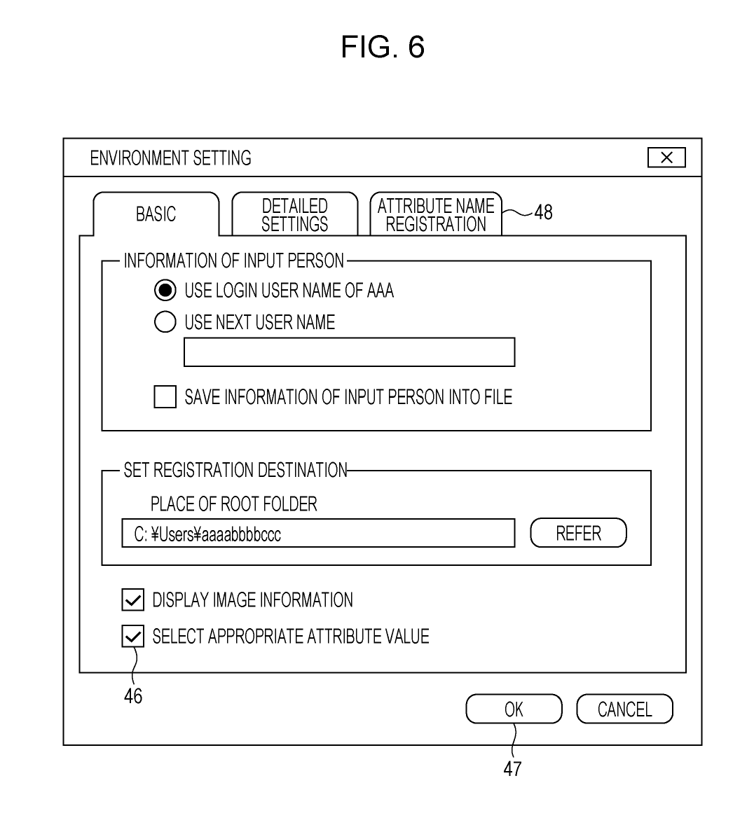

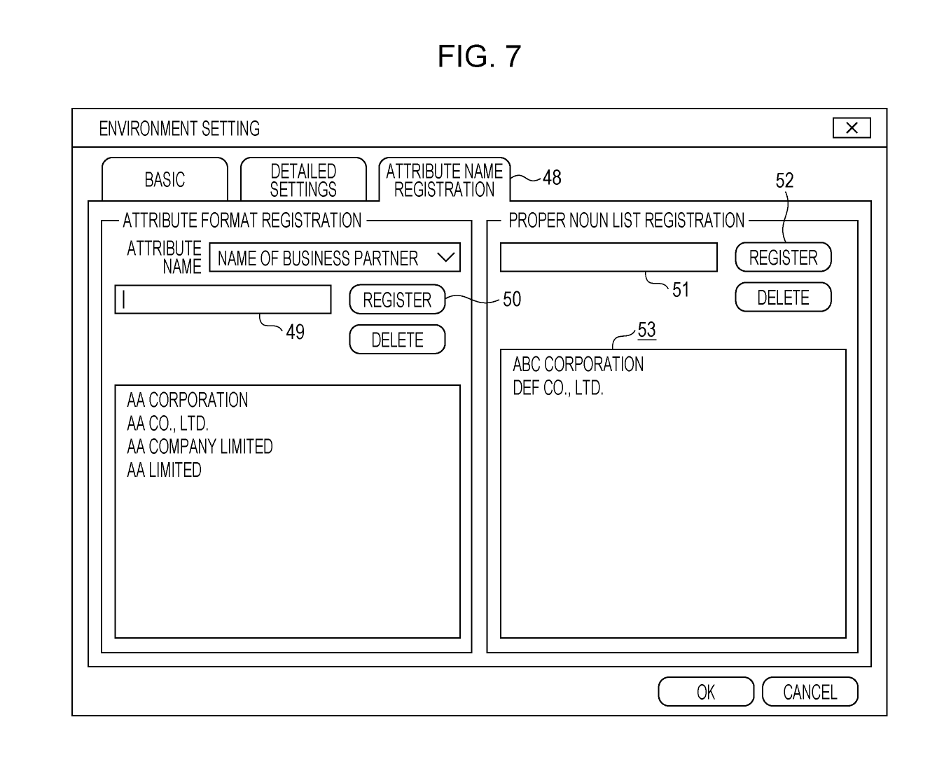

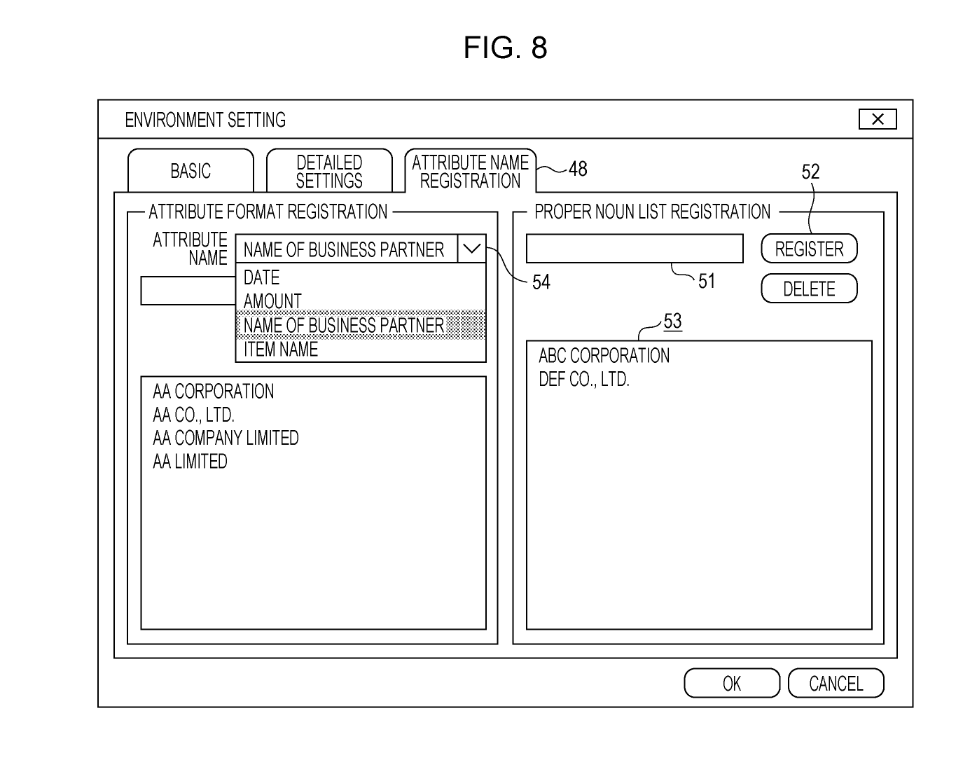

On the display screen illustrated in FIG. 5, when a cursor 45 is clicked while being placed on an “environment setting” button 44 of the tool bar 40, an environment setting screen is displayed as illustrated in FIG. 6. Then, when a check box 46 for “select appropriate attribute value” is ticked and an “OK” button 47 is clicked on the environment setting screen, an operation using determination information such as the format registration information 33, the proper noun registration information 34, and the like may be performed. Then, when an attribute name registration tab 48 is clicked, an attribute name registration screen is displayed as illustrated in FIG. 7 or 8.

A user is able to register determination information on the attribute name registration screens illustrated in FIGS. 7 and 8. That is, the user is able to register new format information in association with the type of attribute and store the registered format information in the format registration information 33. Furthermore, the user is able to register a new type of attribute and store the registered type in the format registration information 33. Furthermore, the user is able to register proper nouns such as a string that may be registered as an attribute, a string that is frequently used as attribute information, and the like and store the registered proper nouns in the proper noun registration information 34.

Specifically, on the display screen illustrated in FIG. 7, for example, a user inputs format information such as “AA Corporation”, “AA Co., Ltd.”, “AA Company Limited”, and “AA Limited” for an attribute name of “name of business partner” to an input field 49 and clicks a registration button 50, so that the format information corresponding to the “name of business partner” may be registered. That is, by registering such format information as the format registration information 33, for example, in the case where an extracted string includes “Limited”, the string may be input as a candidate for attribute information to the input field 43 for an attribute name of “name of business partner”.

Furthermore, on the display screens illustrated in FIGS. 7 and 8, for example, a user inputs a proper noun that may be registered as an attribute or a proper noun that is frequently used as attribute information, such as “ABC Corporation” and “DEF Co., Ltd.”, to an input field 51 and clicks a registration button 52, so that the proper nouns such as “ABC Corporation” and “DEF Co., Ltd.” may be registered. The proper noun registration information 34 may be used to perform correction in a case where there is an error such as a shortage or excess in an extracted string, for example, in a case where an unwanted letter is input in a string in a specified region, and to input the corrected string as a candidate for attribute information. Furthermore, on a proper noun registration screen 53, a proper noun that is displayed in a higher place in the display order is preferentially used as attribute information compared to a proper noun that is displayed in a lower place in the display order.

Furthermore, on the display screen illustrated in FIG. 8, a user clicks a pulldown mark 54 so that a type of attribute such as “date”, “amount”, or “item name” may be additionally registered as a new type of attribute (attribute name) and corresponding format information may be registered with respect to the additionally registered type of attribute.

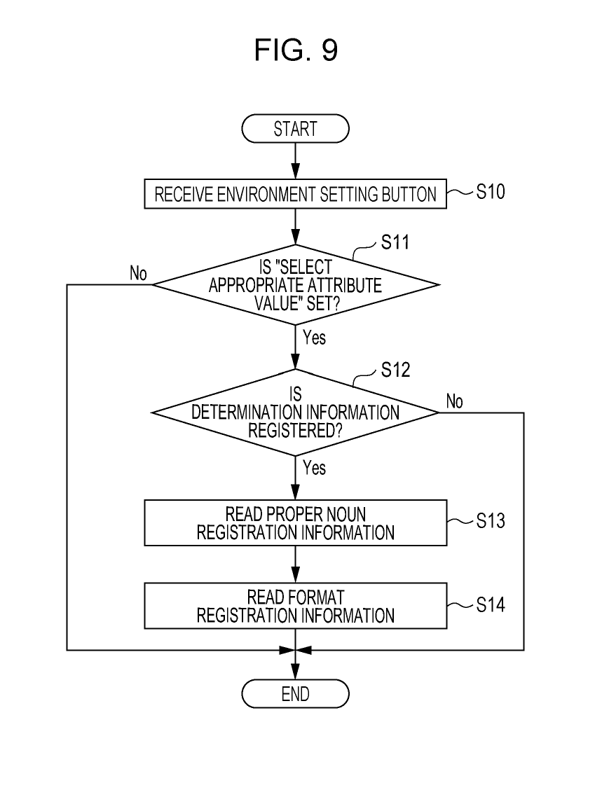

Next, a setting operation at the document processing apparatus 10 for adding an attribute to document data will be described with reference to FIGS. 5, 6, and 9.

First, on the display screen illustrated in FIG. 5, when the “environment setting” button 44 is clicked, the environment setting button is received (step S10), and the environment setting screen illustrated in FIG. 6 is displayed. Then, it is determined whether or not the check box 46 for “select appropriate attribute value” is ticked on the environment setting screen (step S11). When the “OK” button 47 is clicked in a state in which the check box 46 for “select appropriate attribute value” is not ticked (No in step S11), the process ends, and a manual input mode for allowing a user to manually input attribute information without using determination information such as the format registration information 33, the proper noun registration information 34, or the like is entered.

When the “OK” button 47 is clicked in a state in which the check box 46 for “select appropriate attribute value” is clicked on the environment setting screen (Yes in step S11), it is determined whether or not determination information such as the format registration information 33, the proper noun registration information 34, or the like is registered (step S12). In the case where it is determined that determination information is not registered (No in step S12), the process ends, and the manual input mode is entered.

In the case where it is determined that determination information is registered (Yes in step S12), the proper noun registration information 34 is read from the storage device 19 (step S13), the format registration information 33 is read (step S14), and an automatic input mode for allowing a candidate for attribute information to be automatically input using the determination information such as the format registration information 33 and the proper noun registration information 34 is entered.

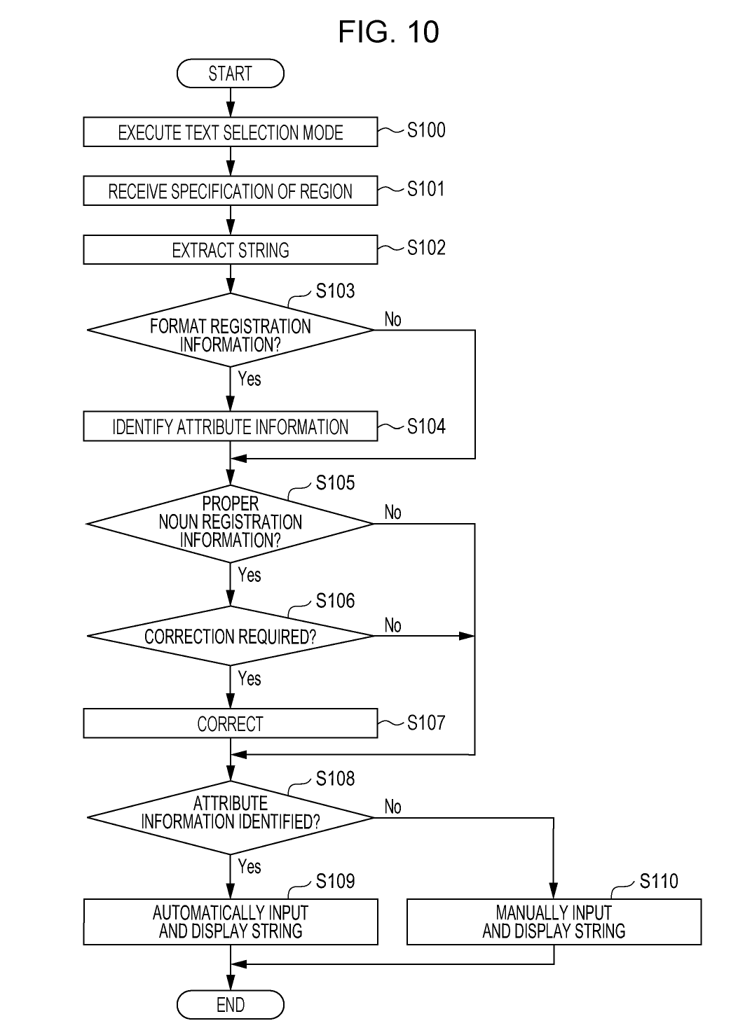

Next, an operation for adding attribute information to document data in the document processing apparatus 10 will be described in detail with reference to FIGS. 10 to 13.

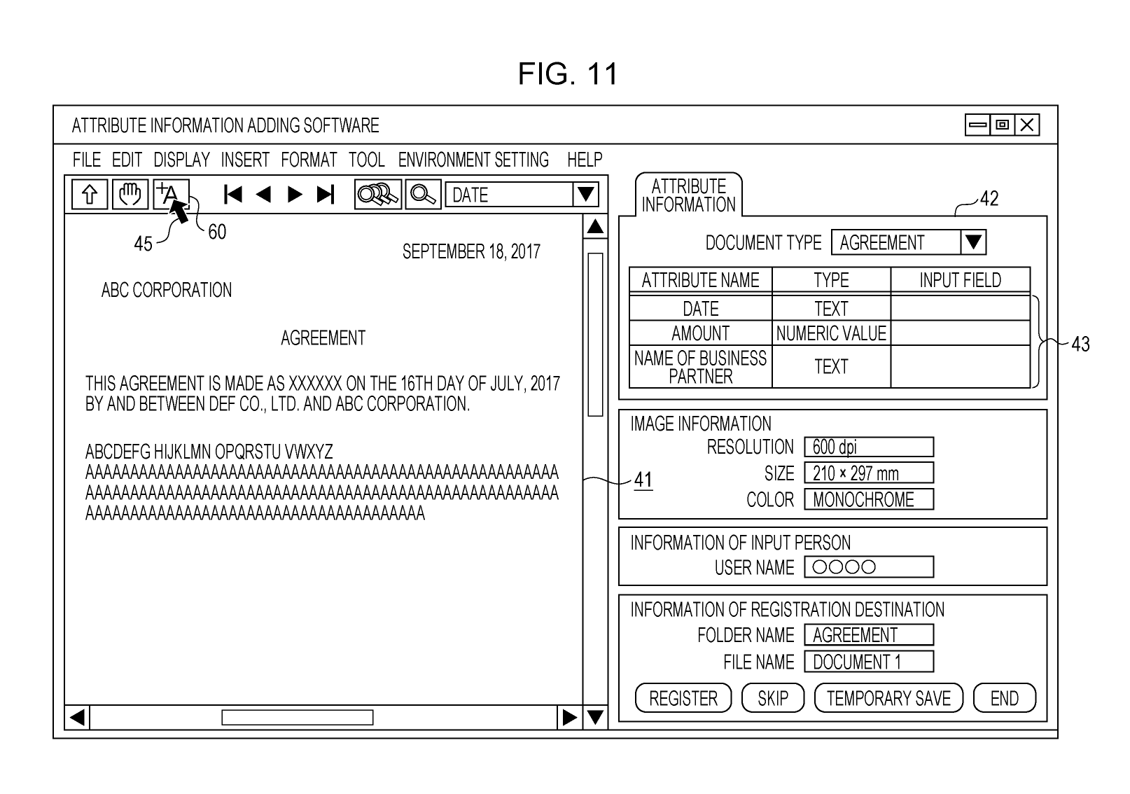

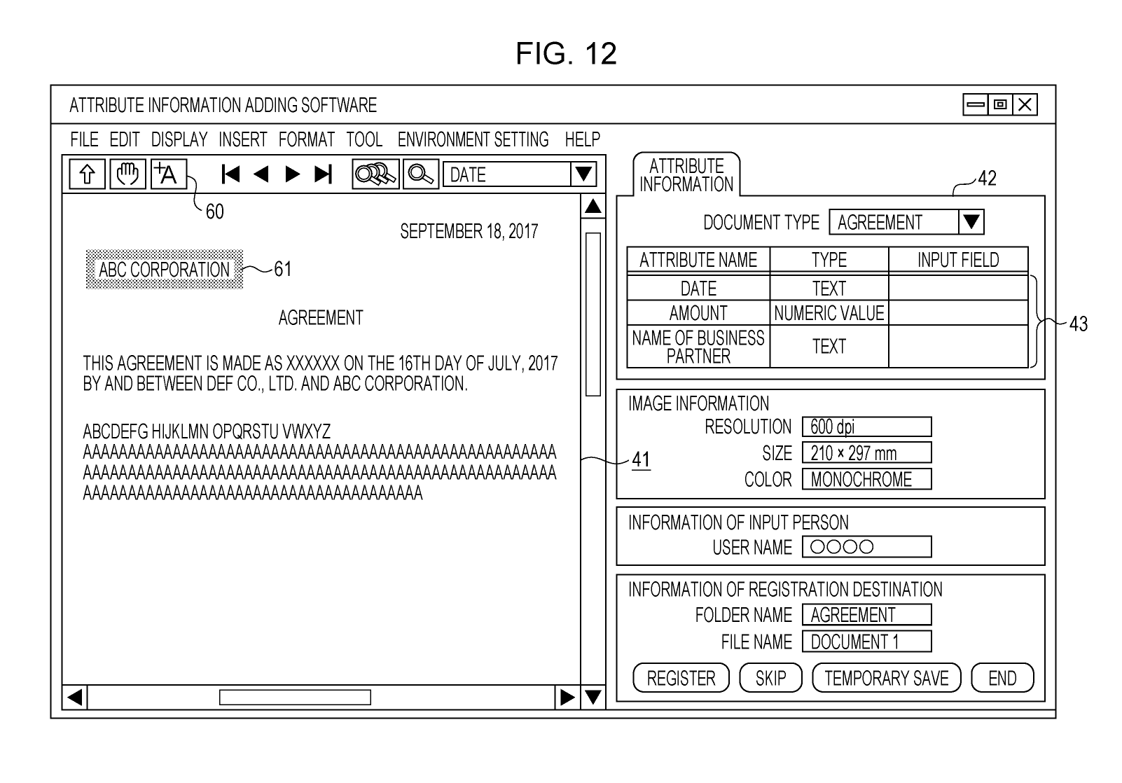

First, a text selection mode is executed by a user (step S100), and specification of a region 61 including a string that is desired to be used as attribute information is received by the region specification reception unit 24 (step S101). Specifically, for example, when the user clicks the cursor 45 that is placed on a text selection button 60 illustrated in FIG. 11, a text selection mode in which text may be selected is executed. Then, as illustrated in FIG. 12, the user specifies a range by dragging, with the cursor 45, the region 61 including, for example, “ABC Corporation” that is desired to be added as attribute information to the document data displayed on the view screen 41.

Then, a string is extracted from the specified region (step S102), and it is determined whether or not the extracted string is the format registration information 33 (step S103). For example, it is determined whether or not the extracted string is a string such as “Limited” or “Co., Ltd” or a string including Arabic numerals such as 1, 2, and 3 or Chinese characters expressing numerals. Specifically, when “ABC Corporation” is extracted from the specified region 61, it is determined whether or not the extracted character string is the format registration information 33.

Then, in the case where it is determined that the extracted string is the format registration information 33 (Yes in step S103), attribute information is identified based on the format registration information 33 (step S104). Specifically, when it is determined that the extracted “ABC Corporation” is the format registration information 33, an attribute name of “name of business partner” corresponding to format information of “Corporation” in “ABC Corporation” is identified.

In the case where attribute information is identified based on the format registration information 33 (step 5104) or it is determined that the extracted string is not the format registration information 33 (No in step S103), it is determined whether or not the extracted string is the proper noun registration information 34 registered in advance (step S105).

In the case where it is determined that the extracted string is the proper noun registration information 34 registered in advance (Yes in step S105), the extracted string is compared with the proper noun registration information 34 and it is determined whether or not the extracted string is to be corrected (step S106). For example, it is determined whether or not an unwanted string is included in the extracted string, whether or not there is a shortage or excess in the extracted string, and the like.

In the case where it is determined that the extracted string is to be corrected (Yes in step S106), the extracted string is corrected based on the proper noun registration information 34 (step S107). That is, correction is performed so that the extracted string becomes the same as the string that is registered as the proper noun registration information 34. Specifically, for example, in the case where the string extracted from a specified region is “, ABC Corporation”, correction is performed so that a comma “,” is deleted and the extracted string thus becomes the same as “ABC Corporation” that is registered as the proper noun registration information 34.

In the case where it is determined that there is no need to correct the extracted string (No in step S106), in the case where the extracted string is corrected based on the proper noun registration information 34 (step S107), or in the case where it is determined that the extracted string is not the proper noun registration information 34 (No in step S105), it is determined whether or not attribute information displayed as a candidate is identified (step S108).

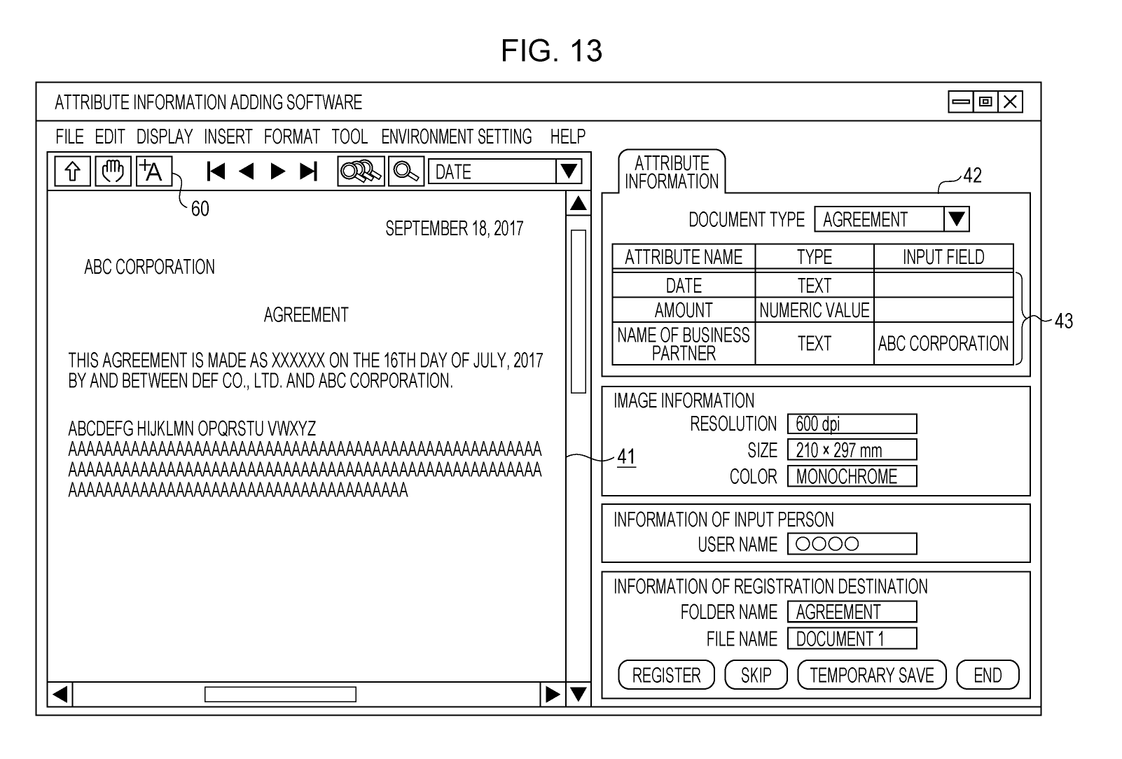

In the case where it is determined that the attribute information is identified (Yes in step S108), the string identified as attribute information is automatically input to the input field 43 of the setting screen 42 for attribute information and is displayed (step S109). Specifically, a type of attribute “name of business partner” is identified based on determination information from “ABC Corporation” extracted from the specified region 61. Then, “ABC Corporation” is automatically input to the input field 43 for the attribute name “name of business partner” of the setting screen 42 for attribute information and is displayed as a candidate for attribute information, as illustrated in FIG. 13.

In the case where it is determined that attribute information is not identified (No in step S108), a string is manually input, by a user operation, to the input field 43 of the setting screen 42 for attribute information and is displayed (step S110).

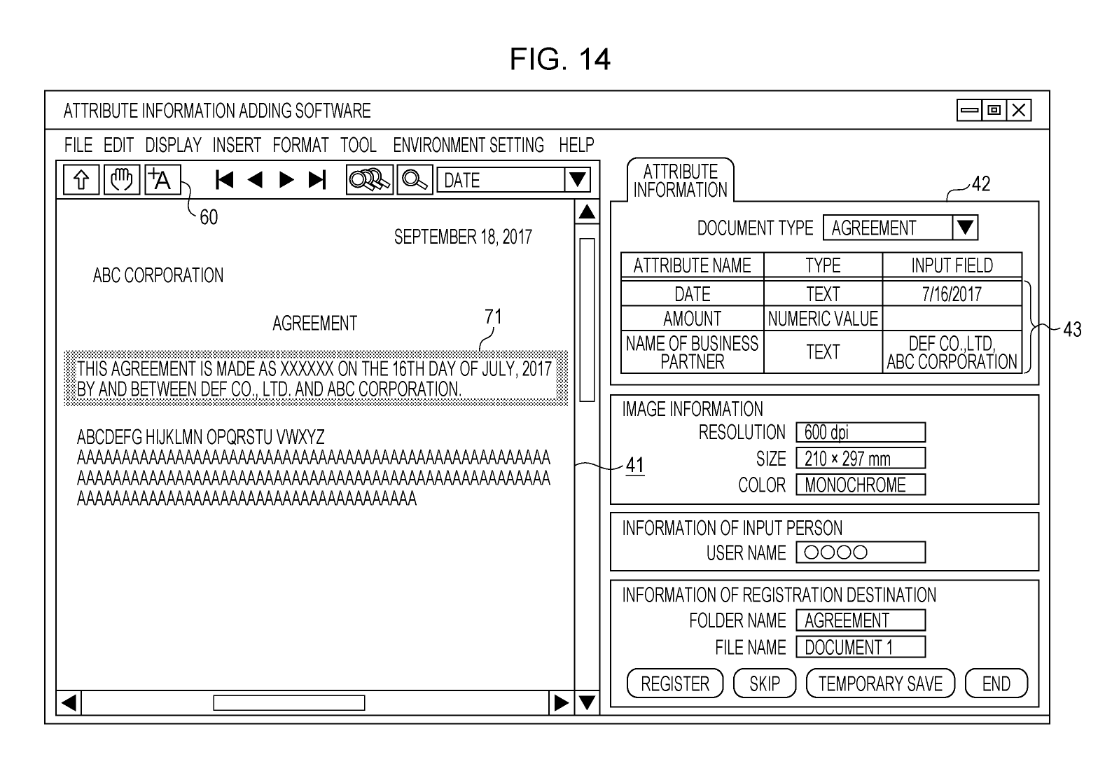

Next, another exemplary embodiment of the present invention will be described with reference to FIG. 14.

In this exemplary embodiment, a case where plural strings exist in a region 71 specified on the view screen 41 for document data will be described.

When the text selection mode is executed and a range is specified by dragging, with a cursor, for example, the region 71 that is desired to be added as attribute information to document data displayed on the view screen 41, as illustrated in FIG. 14, all the strings are extracted from the specified region 71.

Specifically, a range from a space to a pause such as a punctuation mark of a sentence is recognized as a region of a string corresponding to a sentence including plural strings and is resolved into parts of speech such as a proper noun and a particle. In this case, a language written without a space between words may also be recognized, and a space or the like may also be recognized. That is, from the specified region 71, plural strings such as “Jul. 16, 2017”, “DEF Co., Ltd.”, and “ABC Corporation” are extracted.

The plural strings resolved according to parts of speech are acquired, and it is determined whether or not each of the extracted strings is the format registration information 33, based on the format registration information 33 stored in the storage device 19.

In the case where it is determined that each of the extracted “Jul. 16, 2017”, “DEF Co., Ltd”, and “ABC Corporation” is the format registration information 33, an attribute name of “date” corresponding to the format information of “Jul. 16, 2017” is identified as attribute information, and an attribute name of “name of business partner” corresponding to the format information of “ABC Corporation” and “DEF Co., Ltd.” is identified as attribute information.

Then, it is determined whether or not each of the extracted “Jul. 16, 2017”, “DEF Co., Ltd.”, and “ABC Corporation” is the proper noun registration information 34 registered in advance. In the case where each of the extracted “July 16, 2017”, “DEF Co., Ltd.”, and “ABC Corporation” is the proper noun registration information 34 and it is determined, by comparison with the proper noun registration information 34, that the extracted string needs to be corrected, the extracted string is corrected based on the proper noun registration information 34.

Then, it is determined whether or not attribute information is identified. In the case where it is determined that attribute information is identified, the string identified as attribute information is automatically input to the input field 43 of the setting screen 42 for attribute information and is displayed. Specifically, attribute information is identified based on determination information such as the format registration information 33, the proper noun registration information 34, and the like from “Jul. 16, 2017”, “DEF Co., Ltd.”, “ABC Corporation”, and the like extracted from the specified region 71, and “7/16/2017” is automatically input to the input field 43 for an attribute name of “date” on the setting screen 42 for attribute information and is displayed as a candidate for attribute information, as illustrated in FIG. 14. Furthermore, “DEF Co., Ltd.” and “ABC Corporation” are automatically input to the input field 43 for an attribute name of “name of business partner” and are displayed as candidates for attribute information.

Then, a user registers attribute information by manual input or correction if necessary while viewing a screen on which candidates for attribute information are displayed, so that attribute information may be added to document data.

In the foregoing exemplary embodiment, a configuration in which the setting screen 42 for attribute information is displayed on the UI device 20 and processing is executed has been described. However, the present invention is not limited to this. For example, by selecting document data and causing an execution bar to be displayed, for example, by right-clicking a mouse, an execution screen may be displayed, and processing may be executed.

Furthermore, in the foregoing exemplary embodiment, a configuration in which prior to adding attribute information to document data using determination information such as the format registration information 33, the proper noun registration information 34, and the like, format information and a string to be used as determination information are registered in advance in the format registration information 33 and the proper noun registration information 34 on the environment setting screen has been described. However, the present invention is not limited to this. On the setting screen 42 for adding attribute information, registration may be performed by displaying a screen for asking whether or not to register a string extracted from a specified region in the format registration information 33 or the proper noun registration information 34.

### Modifications

In the foregoing exemplary embodiments, a case where the present invention is applied to attribute information adding software has been described. However, the present invention is not limited to this. The present invention may also be applied in a same manner to any type of software including a configuration in which an editing operation is performed on document data or the like.

For example, the present invention may be applied in a same manner to software that performs an editing operation on document data at a portable information terminal apparatus or the like such as a smartphone or a tablet terminal apparatus as well as software that edits document data at a personal computer.

Furthermore, in an exemplary embodiment, a program executed by an information processing apparatus may be provided by being stored in a computer-readable recording medium such as a magnetic recording medium (a magnetic tape, a magnetic disk (an HDD, a flexible disk (FD), etc.), an optical recording medium (an optical disk (a compact disk (CD), a digital versatile disk (DVD)), etc.), a magneto-optical recording medium, a semiconductor memory (a flash ROM etc.), or the like. Furthermore, the above program may be downloaded via a network such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing apparatus comprising:
a reception unit that receives specification of a region in an electronic document by a user; and
a display control unit that performs control such that a candidate for attribute information is displayed from a string in the region received by the reception unit, based on determination information as information for determining a type of attribute information.

2. The document processing apparatus according to claim 1,
wherein the determination information is format information corresponding to a type of attribute.

3. The document processing apparatus according to claim 1,
wherein the determination information is a string that may be registered as an attribute.

4. The document processing apparatus according to claim 3, further comprising:
a correction unit that corrects a string in the region in accordance with the determination information,
wherein the display control unit performs control such that the string corrected by the correction unit is displayed as a candidate for attribute information.

5. The document processing apparatus according to claim 4,
wherein the correction unit performs correction so that the string in the region becomes the same as a string registered as the determination information.

6. The document processing apparatus according to claim 1,
wherein in a case where the region includes a plurality of strings registered as the determination information, the display control unit performs control such that the plurality of strings are displayed as candidates for attribute information.

7. The document processing apparatus according to claim 2,
wherein in a case where the region includes a plurality of strings registered as the determination information, the display control unit performs control such that the plurality of strings are displayed as candidates for attribute information.

8. The document processing apparatus according to claim 3,
wherein in a case where the region includes a plurality of strings registered as the determination information, the display control unit performs control such that the plurality of strings are displayed as candidates for attribute information.

9. The document processing apparatus according to claim 4,
wherein in a case where the region includes a plurality of strings registered as the determination information, the display control unit performs control such that the plurality of strings are displayed as candidates for attribute information.

10. The document processing apparatus according to claim 5,
wherein in a case where the region includes a plurality of strings registered as the determination information, the display control unit performs control such that the plurality of strings are displayed as candidates for attribute information.

11. The document processing apparatus according to claim 6,
wherein the display control unit performs control such that the strings are displayed, based on the determination information, as candidates for attribute information in a plurality of types of input field corresponding to the strings.

12. The document processing apparatus according to claim 7,
wherein the display control unit performs control such that the strings are displayed, based on the determination information, as candidates for attribute information in a plurality of types of input field corresponding to the strings.

13. The document processing apparatus according to claim 8,
wherein the display control unit performs control such that the strings are displayed, based on the determination information, as candidates for attribute information in a plurality of types of input field corresponding to the strings.

14. The document processing apparatus according to claim 9,
wherein the display control unit performs control such that the strings are displayed, based on the determination information, as candidates for attribute information in a plurality of types of input field corresponding to the strings.

15. The document processing apparatus according to claim 10,
wherein the display control unit performs control such that the strings are displayed, based on the determination information, as candidates for attribute information in a plurality of types of input field corresponding to the strings.

16. A non-transitory computer readable medium storing a program causing a computer to execute a process for document processing, the process comprising:
receiving specification of a region in an electronic document by a user; and
performing control such that a candidate for attribute information is displayed from a string in the received region, based on determination information as information for determining a type of attribute information.

17. A document processing apparatus comprising:
reception means for receiving specification of a region in an electronic document by a user; and
display control means for performing control such that a candidate for attribute information is displayed from a string in the region received by the reception means, based on determination information as information for determining a type of attribute information.
